(19) United States
(12) Patent Application Publication
(10) Pub. No.: US 2005/0022019 A1
(43) Pub. Date: Jan. 27, 2005

(54) Enforcement of playback count in secure hardware for presentation of digital productions

(75) Inventors: Alexander Medvinsky, San Diego, CA (US); Eric Sprunk, Carlsbad, CA (US)

Correspondence Address: CARPENTER & KULAS, LLP, 1900 EMBARCADERO ROAD, SUITE 109, PALO ALTO, CA, 94303, US

(73) Assignee: General Instrument Corporation, Horsham, PA (US)

(21) Appl. No.: 10/613,868

(22) Filed: Jul. 5, 2003

(51) Int. Cl. H04L 9/00

(52) U.S. Cl. 713/201

(57) ABSTRACT

A system for restricting playback of an electronic presentation, such as a digital video or song. The system uses a playback time limit that specifies a duration of allowable playback time. The playback time limit is typically longer than the running time of the presentation so that a user is able to use standard transport controls such as pause, stop, rewind, fast forward, etc., that affect the overall playback time needed to view the presentation in its entirety. One approach uses a secure time base that is provided by a server over a network to a client device that includes a playback device. The secure time base is received and used by secure processing within the playback device. This approach allows rendering of the presentation to an output device to be performed by non-secure processing without unduly compromising the security of the system.

### CROSS-REFERENCES TO RELATED APPLICATIONS

This application is related to the following co-pending U.S. patent applications which are hereby incorporated by reference as if set forth in full in this specification:
Ser. No. 10/334,606, filed on Dec. 30, 2002, entitled “SYSTEM FOR DIGITAL RIGHTS MANAGEMENT USING DISTRIBUTED PROVISIONING AND AUTHENTICATION;” (docket 018926-009900US, D2990);
Ser. No. ______, filed on ______, entitled “EXTENSION OF IPRM-BASED DIGITAL RIGHTS MANAGEMENT TO INCLUDE SUPER DISTRIBUTION OF CONTENT” (docket 018926-011400US, D3055); and
Ser. No. 10/345,075 filed Jan. 14, 2003, entitled “CATEGORIZATION OF HOST SECURITY LEVELS BASED ON FUNCTIONALITY IMPLEMENTED INSIDE SECURE HARDWARE” (docket 018926-010200US, D3023).

### BACKGROUND OF THE INVENTION

1. Field of the Invention

This invention is related in general to digital rights management (DRM) systems and more specifically to restricting an end user's use, or playback, of a digital production.

2. Description of the Background Art

Today's digital systems deal with many types of information, or content, used in commerce, education, entertainment, banking, government, etc. Often, such information is transferred over a digital network such as the Internet, local-area network (LAN), campus or home network, or other communication link or scheme. Naturally, one major concern of content owners is to prevent unauthorized use of content, such as restricting a user from playing back an audio or video recording if the user has not properly paid for, or subscribed to, such use.

Restrictions on playback of digital video, audio, or other productions are often in the form of a “playback count.” For example, a user may purchase the right to view a movie once, only. Additional viewings should be purchased accordingly. While this simple approach would seem to be effective, there are at least two reasons why enforcement of the playback count is difficult and has drawbacks.

Playback hardware typically resides in a user's home. Because of this, the playback devices are prone to being tampered with, “attacked,” or “hacked,” by unscrupulous “attackers.” For example, if the playback count is a value that is kept in a memory of the playback device, an attacker can modify the memory location to set the count back to one even after content has been played back.

One way that the prior art attempts to stop such rudimentary attacks is by using secure processors in the playback devices, or in other devices such as servers, set-top boxes or other network-related components. The use of secure processors prevents attackers from modifying the operation of the devices and can prevent many types of attacks. However, digital content needs to be rendered just prior to presentation to a user.

For example, a popular digital video format is that promulgated by the Motion Picture Experts Group (MPEG) known as MPEG-4. The software decoder for this format often runs “in the clear” outside of any secure processor environment. Even if MPEG-4 decompression is done inside a secure processor, a content rendering application (e.g., a player) is usually an application running in an insecure environment and sends the decompressed clear content to an analog or digital output port that is also typically not physically secure. This means that an attacker might be able to “trick” the process that is trying to enforce the playback count (which is usually a content rendering application) by, e.g., preventing the enforcing process from ever detecting that playback has completed.

Another drawback of limiting playback of digital content is that most systems allow a user to interrupt and control playback by using common “transport” controls such as pause, rewind, fast forward, slow motion, stop, etc. If such controls are used then playback is not continuous. It is complicated to tell, for example, whether a user has completed viewing a presentation if the presentation is viewed in sections and at different times, or if portions of the presentation are skipped and then later visited for review.

### SUMMARY OF EMBODIMENTS OF THE INVENTION

The invention provides a system for restricting playback of an electronic presentation, such as a digital video presentation, song, etc. The system uses a playback time limit parameters that specifies a length, or duration, of allowable playback time. The playback time limit is typically longer than the running time of the presentation so that a user is able to use standard transport controls such as pause, stop, rewind, fast forward, variable rate forward and reverse play, etc., that affect the overall playback time needed to view the presentation in its entirety. A preferred embodiment of the invention allows a user to view a presentation for 1.75 times the running time.

One embodiment uses a secure time base that is provided by a server over a network to a client device that includes a playback device. The secure time base is received and used by secure processing within the playback device. This approach allows rendering of the presentation to an output device to be performed by non-secure processing without unduly compromising the security of the system.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings, by way of example only, wherein:

One embodiment of the invention provides a method of limiting playback of an electronic presentation in a digital rights management system, wherein a playback device is used to play back the electronic presentation, the method comprising transferring a playback time limit to the playback device, wherein the playback time limit is used to restrict playback of the electronic presentation according to a measure of actual cumulative playback time of the electronic presentation by the playback device.

Another embodiment provides a method for limiting playback of an electronic presentation on a playback device, the method comprising receiving a playback time limit; measuring actual playback time of the electronic presentation at the playback device; and comparing the actual playback time with the playback time limit to determine whether to permit additional playback of the electronic presentation.

Another embodiment provides an apparatus for limiting playback of an electronic presentation on a playback device, the apparatus comprising a receiver for receiving a playback time limit; a detector for measuring actual playback time of the electronic presentation at the playback device; and a comparator for comparing the actual playback time with the playback time limit to determine whether to permit additional playback of the electronic presentation.

Another embodiment provides a computer-readable medium including instructions executable by a processor for limiting playback of an electronic presentation in a digital rights management system, wherein a playback device is used to play back the electronic presentation, the computer-readable medium comprising one or more instructions for transferring a playback time limit to the playback device, wherein the playback time limit is used to restrict playback of the electronic presentation according to a measure of actual cumulative playback time of the electronic presentation by the playback device.

Another embodiment provides a computer-readable medium including instructions executable by a processor for limiting playback of an electronic presentation on a playback device, the computer-readable medium comprising one or more instructions for receiving a playback time limit; one or more instructions for measuring actual playback time of the electronic presentation at the playback device; and one or more instructions for comparing the actual playback time with the playback time limit to determine whether to permit additional playback of the electronic presentation.

### BRIEF DESCRIPTION OF THE DRAWINGS

FIG. 1A shows components in an Internet Protocol Rights Management (IPRM) system suitable for use with the present invention;

FIG. 1B shows additional components relating to home domain access of information provided by a digital rights management (DRM) system such as the IPRM system of FIG. 1A;

FIG. 2 shows the structure of a Session Rights Object (SRO);

FIG. 3 illustrates secure and non-secure processing within a playback device; and

FIG. 4 shows a flowchart of a routine that handles playback restriction.

### DETAILED DESCRIPTION OF EMBODIMENTS OF THE INVENTION

A preferred embodiment of the invention is used with a specific digital rights management (DRM) architecture that is discussed in the related patents, cited above. This architecture is referred to as an Internet Protocol Rights Management (IPRM) system. It should be apparent that different embodiments can use different DRM architectures and features than those discussed herein and in the related patent applications. Different logical and/or physical components than those discussed for the IPRM can be used. Not all components need to be used in any given DRM architecture, and additional components, interconnections, functions and working relationships can be employed.

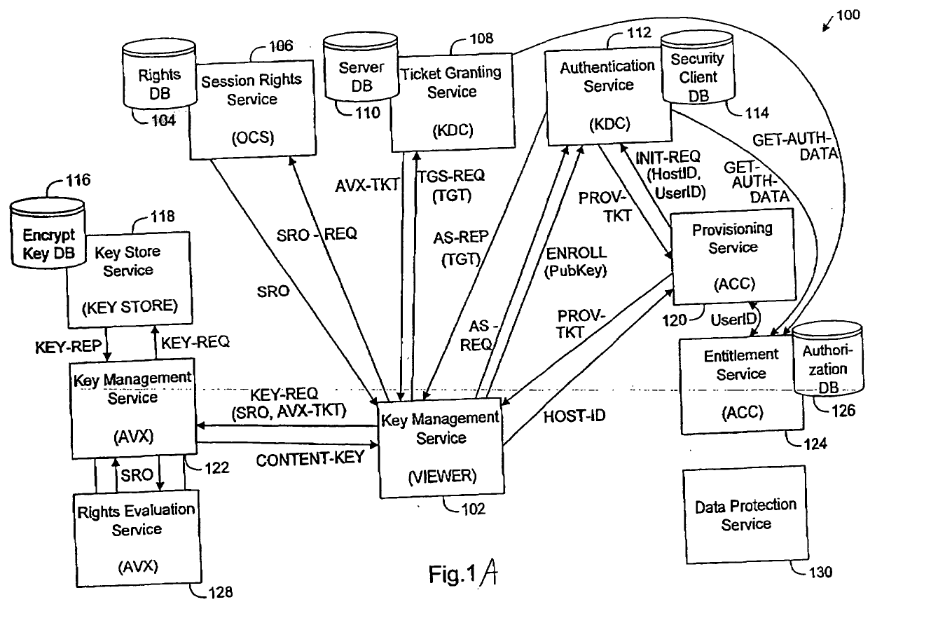

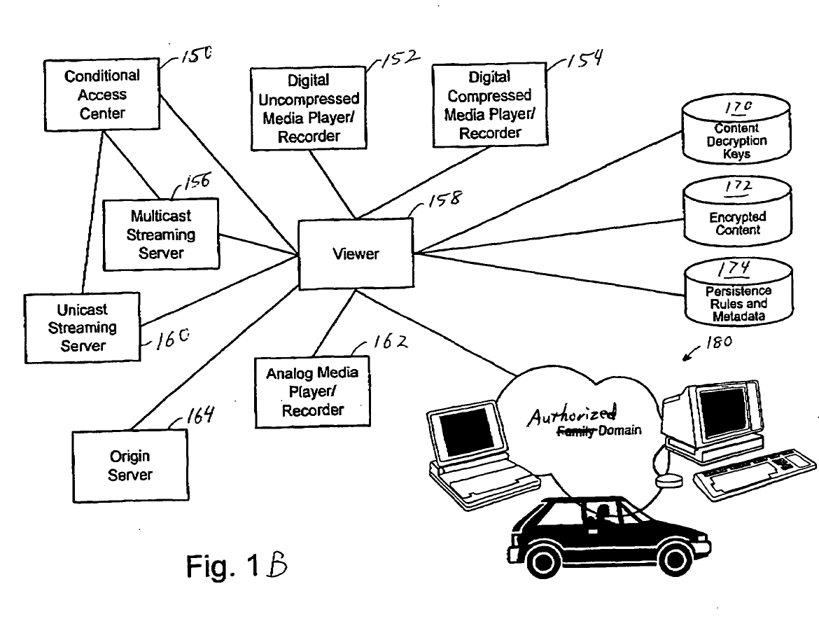

FIG. 1A shows components in an Internet Protocol Rights Management (IPRM) system suitable for use with the present invention.

In FIG. 1A, logical components are shown in boxes with an indication of the physical component that is, preferably, used to perform the functionality of the logical component in parenthesis. Note that FIG. 1A is merely a broad, general diagram of a one content distribution system. The functionality represented by logical components can vary from that shown in FIG. 1A and still remain within the scope of the invention. Logical components can be added, modified or removed from those shown in FIG. 1A. The physical components are examples of where logical components described in the diagram could be deployed. In general, aspects of the present invention can be used with any number and type of devices interconnected by a digital network.

FIG. 1A shows interfaces in the IPRM designed for secure content distribution and for the enforcement of rights of content and service providers. Such a system is used, for example, with satellite and cable television distribution channels where standard television content, along with digital information such as files, web pages, streaming media, etc., can be provided to an end user at home via a set-top box. IPRM system 100 is illustrated using a few exemplary logical components. In an actual system, there will be many more instances of specific logical components. For example, key management service 102 is intended to execute at a user, or viewer location. Naturally, there will be millions of viewers in a typical cable television network.

The general purpose and operation of various of the entities of FIG. 1A, such as provisioning service (PS) 120, authentication service (AS) 112, entitlement service 124, client processors and other servers and devices are well-known in the art. A system such as that shown in FIG. 1A is discussed in more detail in co-pending patent application SYSTEM FOR DIGITAL RIGHTS MANAGEMENT USING DISTRIBUTED PROVISIONING AND AUHENTICATION, referenced above. The system of the present invention can be used among any of the components and physical and logical devices shown in FIG. 1A so that a decision can be made whether to restrict playback of content, or playback or other access to information in general.

FIG. 1B shows additional components relating to home domain access of information provided by a DRM system such as the IPRM system of FIG. 1A. The system of FIG. 1B can be considered as a subsystem, additional system, or overlay to that of FIG. 1A. Although FIG. 1B shows hardware devices, such devices (e.g., viewer 158) can perform portions or combinations of the functions or services described in FIG. 1A.

In FIG. 1B, viewer 158 can be a display device, audio playback device, or other media presentation device, such as a television or computer. Viewer 158 is associated with local playback devices for playback of content, such as uncompressed digital media player 152, compressed digital media player 154 and analog media player 162. Such local devices are part of an “authorized domain” of equipment that is easily accessed by a user, or consumer, as illustrated by devices at 180. Note that the authorized domain can include additional networks, such as Ethernet, wireless, home phone network adapter (PNA), etc. and any number and types of devices for accessing, transferring, playing, creating, and managing content.

The authorized domain presents a special problem to security since it typically places content directly at the control of a user. As indicated in FIG. 1B, various devices may provide a user with content in various formats such as uncompressed, compressed, analog, stored, encrypted, etc. Other ways to provide content to the viewer are from remote devices such as conditional access center 150 using multicast streaming server 156 or unicast streaming server 160. Origin server 164 represents other content sources such as, e.g., a third party web site.

Information can be stored locally or remotely from the authorized domain. Sensitive information such as content decryption keys 170, encrypted content 172 and rules and metadata 174 might commonly be stored in devices that are accessible by the user. The system of the present invention can be used to improve security and rights enforcement in components and devices such as those shown in FIG. 1B.

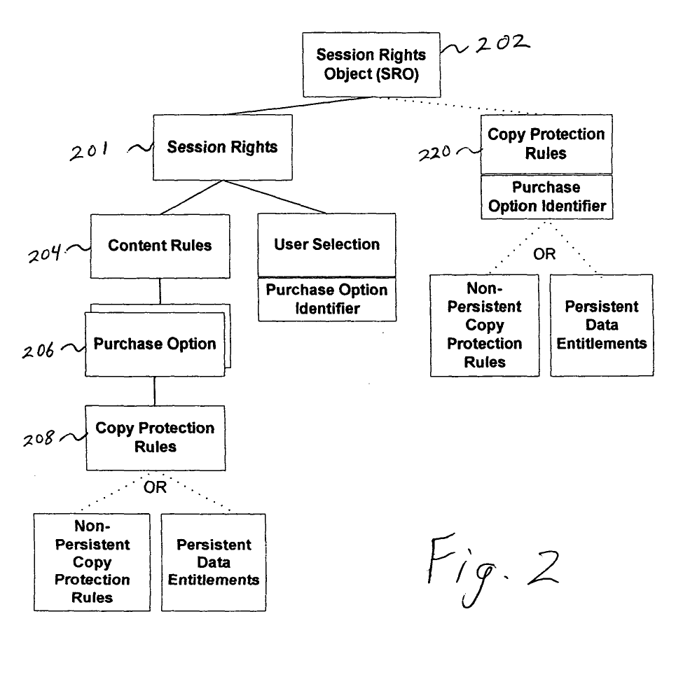

FIG. 2 shows the structure of a data object, called a Session Rights Object (SRO), that is used to convey rules for use of content in a preferred embodiment of the invention. Typically, a user, or playback device, is sent an SRO prior to accessing, or playing back, an electronic presentation such as a digital video, movie, audio file, or other media presentation. The SRO is provided by a server, or other source, that is under the control of an owner, distributor, or other manager of content to be played at the playback device. Note that any other suitable structure or format for an SRO may be used.

As shown in FIG. 2, SRO 202 includes session rights 201 including content rules 204, purchase options 206 and copy protection rules 208. Part of the SRO's session rights also includes a record for user selection 210. Copy protection rules and purchase options 220 can also exist as a separate entity, such as an XML document, from session rights data. Copy protection rules can include non-persistent and persistent rules and entitlements, respectively. The SRO is discussed in more detail in the related patent applications. In a preferred embodiment, portions of the SRO are handled by secure processing within the playback device. For example, processing of SRO data is performed by secure processing and persistent entitlements (or other persistent data) is stored in secure storage.

Persistent data entitlements include information used for playback restriction such as “playback time limit” and “number of plays” parameters. These parameters are stored in secure persistent storage within a device. Other parameters may also be stored, such as “number of copies” that can be made via an external interface to a CDROM or DVD writer, or other copy creation, storage, playback or other device.

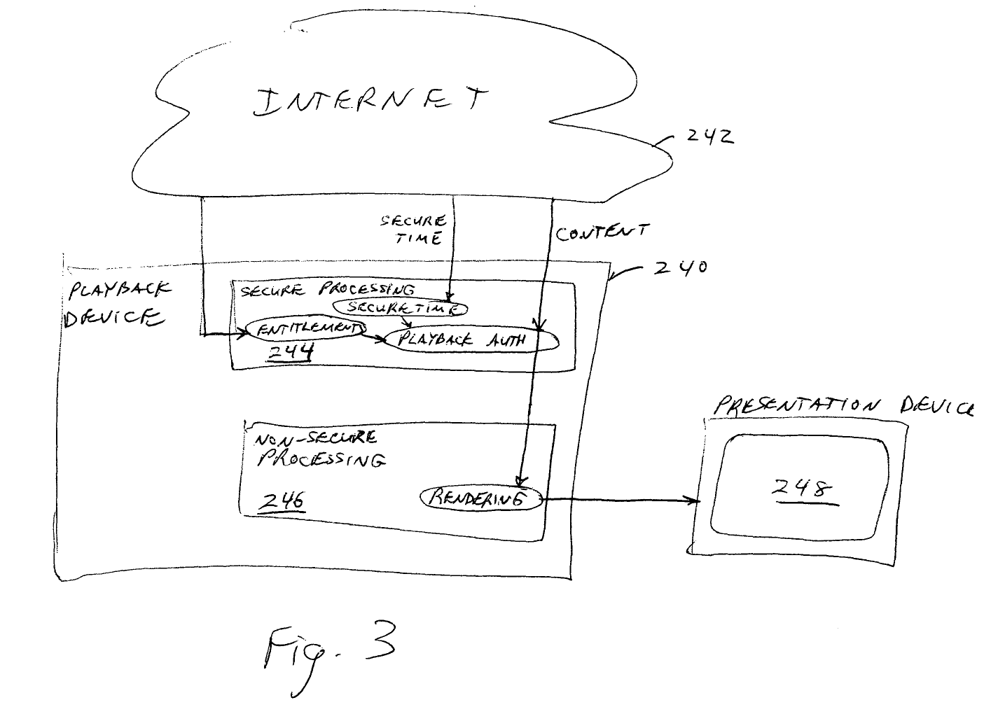

FIG. 3 illustrates secure and non-secure processing within a playback device. In FIG. 3, playback device 240 receives content, session rights, and other information from a source such as Internet 242. Secure processing 244 is used to process data whose unauthorized access might allow an attack on the systeni, such as where a user is able to thwart desired playback restrictions. Secure processing can include any manner or degree of tamper-proof techniques for physical components and software, as is known in the art. Process functions are shown in rounded boxes within secure processing 244 as secure time processing, playback authorization and storage of entitlements. Critical processing, such as decryption, is also performed by secure processing.

Non-secure processing, such as rendering functions, is typically carried out by traditional digital processing techniques without regard (or with less regard than secure processing) to tamper-proof techniques.

In a preferred embodiment, the playback time limit and the number of plays parameters are maintained in secure processing. A user, or subscriber, is allowed to purchase stored content for different periods of time, e.g., hours, days, weeks, months, etc. An authenticated source of time, called “secure time,” is used to enforce the playback time limit. Authenticated time is used to prevent tampering with time readings that enforce content rules that specify time as both relative (content duration) and absolute (time of day). It is usually not sufficient to use a local system clock maintained by a host operating system since the operating system clock can be easily manipulated and can also be bypassed by an attacker by replacing the time of day operating system call. This authenticated clock source must be obtained directly by the client application (i.e., local to the playback device) and should be used in place of the operating system clock. The secure time is used to track the viewing time, or “actual playback time,” of the presentation.

Normally, the resolution of time inside content rules can be coarse, e.g. in units of 5 minutes or even 15 minutes. Thus, an authenticated time source need not be especially accurate and need not be received at a high rate. A client receiving authenticated time should have a timeout within which the next authenticated time reading must be received. If a client does not receive an authenticated clock reading in time, playbacks can be disabled for the types of locally stored content that have an associated expiration time (specified inside a license). Once a client is able to obtain an authenticated time reading, it will again enable playbacks of such content. In the case that authenticated time is received via an IP multicast, this timeout value must be several times larger than the period between authenticated time readings, to avoid disabling clients during accidental loss of individual time readings.

In a preferred embodiment, a secure time protocol specifies messages that allow each individual IPRM client to request secure time readings from a Time Server over point-to-point connections. This method works with point-to-point IPRM clients as well as with IPRM clients that are enabled for IP multicast.

A preferred embodiment of the invention derives the playback time limit as a presentation's running time plus an additional playback time. The additional playback time is added to the minimum amount of time (i.e., the running time) to view a presentation so that a user can use standard playback transport controls such as pause, stop, rewind, variable rate forward, variable rate reverse, etc., as desired. These so-called “trick modes” can all potentially add, or reduce, the viewing time from the total required viewing time, or running time, of the presentation. Different ways of specifying the playback time limit are possible. For example, where the “additional playback time” is not specifically provided, or calculated, a default approach can be taken such as by using 75% of the running time for the additional playback time. This default amount is sufficient to allow a viewer to use a significant amount of trick modes without permitting two full viewings of the content.

Secure processing is used to perform a comparison of secure time with the flow of clear (decrypted) content information to a rendering process. Actual playing time is obtained by tracking the clear content flow in association with secure time. The actual playing time is compared to the playback time limit stored in the entitlements. Preferably, this comparison is done inside the client device's secure processing module at the time when a non-secure application submits a request for the next portion of the content to be decrypted and decompressed. Other factors can be included in the comparison and are, preferably, handled in the secure processing.

Note that it may be desirable to stop incrementing actual playback time when a viewer activates “stop,” or “pause” controls. Other exceptions to incrementing actual playback time can include “rewind” functions in the case of playback devices (e.g., streamed content, VHS tape drives) where the rewind function does not provide sufficiently viewable content.

This could be determined by a secure processor because it will be able to sense the lack of requests to perform decryption. For example, when the security processor does not receive any decrypt requests within a period of time T_{PAUSE} that is greater than a threshold value T_{THRESH}, the time T_{PAUSE} is subtracted from the actual playback time so far T_{PLAY}. (The alternative of trusting an insecure application to tell a secure processor when a pause has occurred is not sufficiently secure.)

The approach of time-limiting playback of content can also be applied when the content is allowed to be played back more than once. For example, a “number of plays” parameter (e.g., stored in the entitlements) can be checked after the playback time limit is reached. If the number of plays parameter is greater than 1, then the parameter is decremented and playback is allowed to continue. Preferably, the user should be notified when a current playback has expired and be given an option to start the next playback or to stop rendering the content.

Other embodiments can use any other type of rule to restrict playback of content by controlling a decryption process in response to a requesting process' request for decrypted information. The control process receives a request from the requesting process (e.g., rendering process) for a portion of the next content to present. The control process can apply an access rule (e.g., playback time limit as discussed above) and then direct that the decryption process be applied to a next portion of content. The output of the decryption process, i.e., the decrypted content, is supplied to the requesting process.

Thus, the present invention allows restriction of content, or other information, to occur by control of the decryption process. Any type of access rule, criteria or other conditions or events can be used by a control process to determine whether decryption of information should be permitted. For example, a check of a locally-stored value or condition, a check on a remotely stored value (e.g., on a server), receipt of an external electronic signal, detection of a keycode being entered, or other condition can be used to allow decryption. The decision to grant a requesting process access to information, and the extent to which decrypted information is provided to the requesting process can vary, as desired, in different embodiments.

By restricting access based on decryption a control process (or other process) can also infer whether trick modes are being used by the frequency and amount of requested decryption. If a threshold time period is exceeded during which there are no (or too few) requests for decrypted information then it can be assumed that a trick mode is being used during which the production is not being displayed in an effective manner.

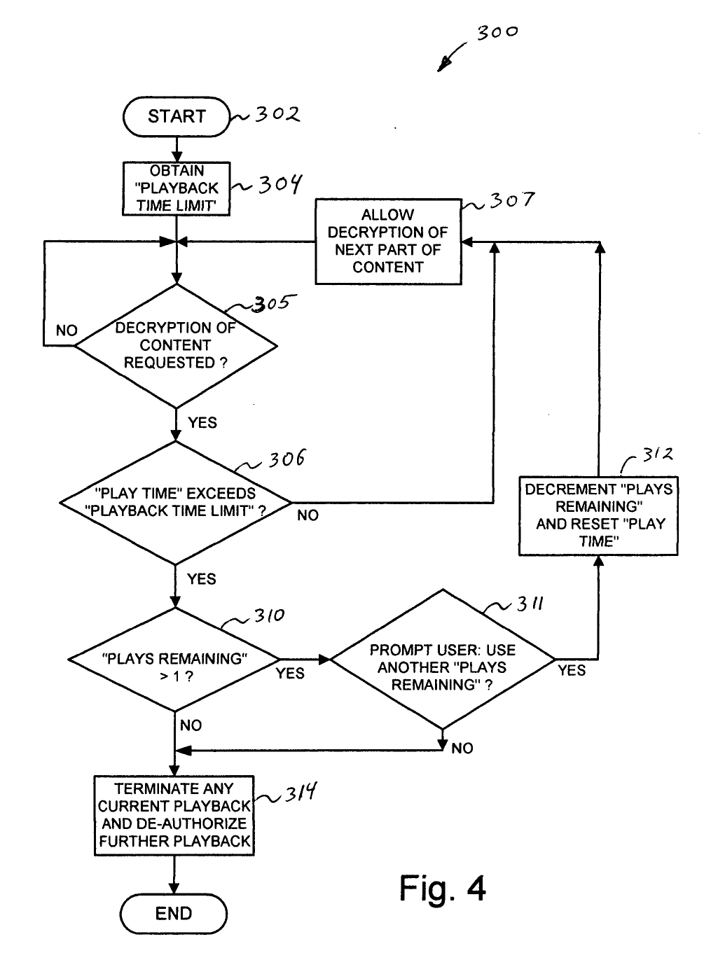

FIG. 4 shows a flowchart of a routine that handles playback restriction.

In FIG. 4, flowchart 300 illustrates basic steps of a routine to restrict playback of a presentation according to a preferred embodiment of the present invention. Flowchart 300 is entered at step 302 when it is desired to monitor and restrict playback usage according to a playback time limit. At step 304 the current playback time limit is obtained. As discussed, above, the “playback time limit” parameter can be obtained in a content license, such as in a data object, via a network at some time prior to playback of the associated content. The playback time limit can also be obtained by other means such as embedded with the presentation, or content, received from a source other than the network, etc.

At step 305 a check is made to determine whether a request to decrypt content is being made. A preferred embodiment contemplates non-secure processing being used for rendering of decrypted data. Secure processing is used to perform the decryption and decompression of an encrypted stream of data received over the Internet. The non-secure processing (or processor) makes a request of the secure processor for a portion, or part, of the content. A portion can be any unit of a presentation such as a frame or number of frames.

When a portion of content is requested for decryption, step 306 is executed to check whether the actual playing time of the presentation up to the present time (including any trick mode use) exceeds the playback time limit. If not, decryption of a next portion of content is accomplished at step 307 and playback of the content continues. When the check at step 306 determines that the actual playback time (i.e., “play time”) has exceeded the playback time limit then execution proceeds to step 310 where the “plays remaining” parameter (if used) is checked.

If the number of plays parameter is greater than one, then step 311 is executed to prompt the user to decide whether or not to use up another remaining play. If the user decides to use another remaining play then step 312 decrements the plays remaining and resets actual playing time to zero. Execution proceeds to step 307 where playback is permitted until the playback time limit is again reached. If, at step 310, the number of plays is 1 (or less) then execution proceeds to step 314 to terminate any current playback and to de-authorize access to the content by the playback device.

Note that various steps of flowchart 300 can be omitted without departing from the scope of the invention. For example, step 311 of prompting a user whether to use another remaining play can be omitted. In general, other embodiments may vary considerably in the number and type of steps from those shown in FIG. 4.

Another approach is to keep track of the number of frames displayed or decrypted instead of, or in addition, to playback time. For example, if a list, count or list of ranges of decrypted frames is maintained then a playback frame limit can be provided that is at least the total number of frames in the running length of a presentation. Additional frames can be allowed to account for trick modes in a similar manner to the approach presented, above, for a playback time limit.

Another possible approach is to allow a user to indicate when viewing has been completed. E.g., by pressing a “done” button on a remote control. The user can be prompted to indicate completion of viewing when a predetermined time limit is reached, or the user can voluntarily indicate completion at any time.

Although a specific embodiment provides for translation of a first criterion, or rule (e.g., a limit on the number of playbacks) to a second rule, e.g., a time limit while taking into account trick modes; that the invention can be used for other types of rule translation to facilitate restricting access to content or other information. For example, in another application a content owner may wish to limit the number of useful playbacks, copies, transfers, or other use of content by decreasing the resolution of video content over time. Or an owner may charge different rates for different resolutions such as a moderate subscription rate for standard television resolution and a higher rate for high-definition broadcasts. However, it may be difficult for a secure processor to enforce such solution limitation because rendering, or display, processes that operate on streamed content can be executed by non-secure processing.

In such a case, the rule for resolution limitation can be translated into a rule to limit the rate at which the secure processor provides decrypted content, or frames, for non-secure processing. Thus, a rule that is easy for a content owner to understand and specify (resolution limitation) is translated into a rule that is practicable for a secure processor to implement (decryption frame rate). Other embodiments can benefit from rule translation in a similar manner to provide different types of restrictions on use of content or information that would otherwise be difficult to enforce.

Thus, although the invention has been discussed with respect to specific embodiments thereof, these embodiments are merely illustrative, and not restrictive, of the invention. For example, although a specific data structure, the SRO, and its transfer over the Internet from a server to a playback device has been discussed, other data structures and delivery approaches can be used. Playback time limit, running time, secure time code and other information can be conveyed to a playback device in any suitable manner. A separate transmission over the Internet or another network, pre-stored data, portable physical media (e.g., CDROM, memory stick, etc.), etc., can be used to convey information used to restrict playback of a presentation.

Different security approaches can be used. For example, different methods of encryption can be used. The selection of which information to encrypt or encode and the authentication and authorization methods of the present invention can be varied and still be within the scope of the invention. Other aspects of the specific embodiments presented herein can be modified.

Although the invention uses secure time that is provided over a network, other embodiments can use a local clock, such as an operating system clock, where less security is desired, or needed. Also, a free-running clock may be obtained from within a secure processing environment and may realize many of the benefits of the secure time of the preferred embodiment. Other approaches for timing and synchronization are possible.

Any suitable programming language can be used to implement the routines of the present invention including C, C++, Java, assembly language, etc. Different programming techniques can be employed such as procedural or object oriented. The routines can execute on a single processing device or multiple processors. Although the flowchart format demands that the steps be presented in a specific order, this order may be changed. Multiple steps can be performed at the same time. The flowchart sequence can be interrupted. The routines can operate in an operating system environment or as stand-alone routines occupying all, or a substantial part, of the system processing.

Steps can be performed in hardware or software, as desired. Note that steps can be added to, taken from or modified from the steps in the flowcharts presented in this specification without deviating from the scope of the invention. In general, the flowcharts are only used to indicate one possible sequence of basic operations to achieve a functional aspect of the present invention.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” includes any system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A method of limiting playback of an electronic presentation, wherein a playback device is used to play back the electronic presentation, the method comprising
obtaining a playback time limit for the playback device, wherein the playback time limit is used to restrict playback of the electronic presentation according to a measure of actual cumulative time of the electronic presentation by the playback device.

2. The method of claim 1, wherein the playback time limit is provided in a content license transferred via a network to the playback device.

3. The method of claim 1, wherein the playback time limit is derived from a running time of the electronic presentation.

4. The method of claim 3, wherein the playback time limit is longer than the running time of the electronic presentation.

5. The method of claim 1, wherein a default playback time limit is derived.

6. The method of claim 5, wherein the default playback time limit is derived from a computation.

7. The method of claim 6, wherein the default playback time limit is derived by multiplying a running time of the electronic presentation by 1.75.

8. The method of claim 5, wherein the default playback time limit is derived from a stored value.

9. The method of claim 1, wherein the playback device includes a server that provides streamed content.

10. The method of claim 1, wherein the actual cumulative time does not include intervals where playback is stopped.

11. The method of claim 1, further comprising
obtaining a “number of plays” limit at the playback device, wherein the number of plays limit is used with the playback time limit to restrict playback of the electronic presentation by the playback device.

12. The method of claim 1, wherein the playback device includes both secure and non-secure processing, wherein the playback device is coupled to a server processor via a network, the method further comprising
transferring the playback time limit to the playback device for secure processing; and
using the secure processor to transfer at least a portion of the electronic presentation to the playback device for rendering, at least a portion of the rendering to take place in the non-secure processing.

13. The method of claim 12, wherein a secure processor is used to perform the secure processing, the method further comprising
using the secure processor to receive a secure time signal via the network; and
using the secure time signal with the playback time limit to restrict playback of the electronic presentation by the playback device.

14. The method of claim 1, wherein the actual cumulative time does not include time during which the electronic presentation is not being played back.

15. The method of claim 14, wherein the playback device includes secure processing and non-secure processing, the method further comprising
using the non-secure processing to determine when one of the following modes of playback have been selected by a user: pause, fast forward, rewind, stop, variable speed playback, variable speed rewind;
using the secure processing to update the actual cumulative time in response to one or more of the modes determined by the non-secure processing.

16. The method of claim 15, further comprising
omitting update of the actual cumulative time for the modes of pause, rewind, and stop.

17. The method of claim 16 further comprising
determining whether a mode is being used by monitoring the rate at which a requesting process makes requests for decryption.

18. The method of claim 16, further comprising
omitting update of the actual cumulative time for the mode of fast forward.

19. A method for limiting playback of an electronic presentation on a playback device, the method comprising
receiving a playback time limit;
measuring actual time of the electronic presentation at the playback device; and
comparing the actual playback time with the playback time limit to determine whether to permit additional playback of the electronic presentation.

20. The method of claim 19, wherein the step of comparing is performed in response to a request to decrypt a portion of the electronic presentation.

21. The method of claim 20, wherein the request to decrypt a portion of the electronic presentation is made to a secure processor.

22. The method of claim 19, wherein the playback time limit is provided in a content license transferred via a network to the playback device.

23. The method of claim 19, wherein the playback time limit is derived from a running time of the electronic presentation.

24. The method of claim 23, wherein the playback time limit is longer than the running time of the electronic presentation.

25. The method of claim 19, further comprising
receiving a “number of plays” limit, wherein the number of plays limit is used with the playback time limit to restrict playback of the electronic presentation by the playback device.

26. The method of claim 19, wherein the playback device includes a server that provides streamed content.

27. The method of claim 19, wherein the playback device includes both secure and non-secure processing, wherein the playback device is coupled to a network, the method further comprising
using the secure processing to receive the playback time limit; and
using the non-secure processing to render at least a portion of the electronic presentation.

28. The method of claim 27, wherein a secure processor is used to perform the secure processing, the method further comprising
using the secure processor to receives a secure time signal via the network; and
using the secure time signal with the playback time limit to restrict playback of the electronic presentation by the playback device.

29. The method of claim 19, wherein the actual cumulative time does not include time during which the electronic presentation is not being played back.

30. The method of claim 29, wherein the actual cumulative time does not include time during which the electronic presentation is in one or more of the following modes:
pause, rewind, or stop.

31. An apparatus for limiting playback of an electronic presentation on a playback device, the apparatus comprising
a receiver for receiving a playback time limit;
a detector for measuring actual time of the electronic presentation at the playback device; and
a comparator for comparing the actual playback time with the playback time limit to determine whether to permit additional playback of the electronic presentation.

32. A computer-readable medium including instructions executable by a processor for limiting playback of an electronic presentation in a digital rights management system, wherein a playback device is used to play back the electronic presentation, the computer-readable medium comprising
one or more instructions for transferring a playback time limit to the playback device, wherein the playback time limit is used to restrict playback of the electronic presentation according to a measure of actual cumulative time of the electronic presentation by the playback device.
